(19) United States
(12) Patent Application Publication
(10) Pub. No.: US 2013/0111816 A1
(43) Pub. Date: May 9, 2013

(54) WINDOW REGULATOR FOR VEHICLE

(71) Applicant: Shiroki Corporation, Fujisawa-shi (JP)

(72) Inventor: Kimihiro KINOSHITA, Fujisawa-shi (JP)

(73) Assignee: SHIROKI CORPORATION, Fujisawa-shi (JP)

(21) Appl. No.: 13/668,767

(22) Filed: Nov. 5, 2012

(30) Foreign Application Priority Data
Nov. 7, 2011 (JP) 2011-243056
Nov. 7, 2011 (JP) 2011-243057

(51) Int. Cl. E05F 11/38

(52) U.S. Cl. 49/376

(57) ABSTRACT

A window regulator for a vehicle, includes a slider fixed to a slide windowpane which moves up and down in a vehicle door; a guide rail which is fixed to the door panel, extends in an up/down direction of the slide windowpane and supports the slider; a wire orientation changing member provided the guide rail; a drive wire which is wound around the wire orientation changing member, wherein the drive wire moves up and down with the slider; a drive drum which moves the drive wire up and down; and a slide contact portion which is provided on the guide rail, extends in the up/down direction and is greater in length than the slider in the up/down direction, wherein the slider slides on the slide contact portion when the slider moves up and down.

### BACKGROUND OF THE INVENTION

1. Field of the Invention

The present invention relates to a window regulator, designed for a vehicle, for raising and lowering a slide windowpane of a vehicle door.

2. Description of Related Art

A type of window regulator which guides and moves a slide windowpane along a single guide rail, which extends vertically, is known in the art as an example of a window regulator for raising and lowering a slide windowpane relative to a door panel of a vehicle door.

Japanese Unexamined Patent Publication No. 2006-28973 discloses such a type of window regulator, which is provided with a slider fixed at the lower end of a slide windowpane, a guide rail fixed to a door panel and extends vertically to guide the slider, a drum housing fixed to the door panel to be positioned below the guide rail and which is connected to the lower end of the guide rail, a drive drum which is rotatably supported by the drum housing and is rotatably driven by a motor, a pulley which is rotatably installed in the upper end of the guide rail, and a drive wire provided in association with the drive drum while being wound around the pulley, a middle part of which is fixed to the slider.

Rotatably driving the drive drum via the motor causes the drive wire to move vertically in association with the drive drum while rotating the pulley, thereby causing the slide windowpane, which is integral with the slider, to move up and down to shut and open a window opening of a vehicle door.

Since the guide rail disclosed in the above-mentioned Japanese Unexamined Patent Publication No. 2006-28973 is made of metal, a surface of the guide rail needs to be greased (more specifically, the entire surface of the guide rail which is in sliding contact with the slider needs to be greased). If this surface (slide contact surface) is not greased, slide friction resistance of the slider, which is made of synthetic resin, against the guide rail becomes great, so that slide movements of the slider become unsmooth. Additionally, abrasion between portions of the guide rails and the slider which are in sliding contact with each other is accelerated.

However, if the guide rail is greased, there is a possibility of the hands of the assembly worker getting dirty during installation of the guide rail in a vehicle door. In addition, the requirement for application of grease to the guide rail also increases the production cost of the guide rail.

### SUMMARY OF THE INVENTION

The present invention provides a window regulator for a vehicle which allows the slider to slide smoothly on the guide rail without the need to grease a surface of the guide rail and which additionally enables a reduced abrasion between the mutually sliding portions of the guide rail and the slider in an effective manner.

According an aspect of the present invention, a window regulator for vehicle is provided, including a slider fixed to a slide windowpane which moves up and down relative to a door panel of a vehicle door of the vehicle; a guide rail which is fixed to the door panel, extends in an up/down direction of the slide windowpane and supports the slider in a manner to allow the slider to slide on the guide rail in the up/down direction; a wire orientation changing member provided the guide rail; a drive wire which is wound around the wire orientation changing member, wherein the drive wire moves up and down with the slider; a drive drum which moves the drive wire up and down; and a slide contact portion, made of resin, which is provided on the guide rail, extends in the up/down direction and is greater in length than the slider in the up/down direction, wherein the slider slides on the slide contact portion when the slider moves up and down.

According to the present invention, the slider can smoothly slide on the guide rail even if the slide contact portion of the guide rail is not greased because the slide contact portion of the guide rail is made of resin.

In addition, since no application of grease to the guide rail is required, there is no possibility of the hands of the assembly worker getting dirty during installation of the guide rail to a vehicle door; additionally, a reduction in production cost of the guide rail can be achieved.

Moreover, since the slide contact portion that is formed on the guide rail is greater in length than the slider, the entire slide contact portion does not simultaneously contact the slider; in other words, points (portions) of the entire slide contact portion sequentially come in slide contact with the slider, so that the slide contact portion does not easily wear.

It is desirable for the slide contact portion to include a protrusion which protrudes toward the slider.

If the slide contact portion is formed into a protrusion, slide movements of the slider on the guide rail become smoother.

It is desirable for a hollow portion to be formed in the protrusion, the hollow portion extending in an elongated direction of the protrusion.

Accordingly, the protrusion in which the hollow portion is formed is resiliently deformable. Hence, when the slider (slide windowpane) vibrates in the widthwise direction or the forward/rearward direction of the vehicle, this vibration can be absorbed by the protrusion, in which the hollow portion is formed.

It is desirable for the guide rail to be an extrusion product made of resin.

Accordingly, the guide rail is made as an extrusion product made of resin, so that a reduction in weight of the guide rail can be achieved (compared with the case where the guide rail is made of metal). Moreover, the production cost of the guide rail can be reduced (compared with a guide rail made as a resin-made injection-molded product).

It is desirable for the guide rail to be a product molded out of at least two types of resin materials, and for the slide contact portion to be made of a resin material which has a smaller slide friction resistance with respect to the slider than a resin material of a portion of the guide rail other than the slide contact portion.

Accordingly, since the guide rail is an extrusion product made of resin, the production cost of the guide rail can be reduced even though the guide rail is molded of two types of materials.

In addition, since the slide contact portion of the guide rail that is in contact with the slider is made of one of the two types of resin materials which is smaller in slide friction resistance than the other type, the slider can be made to slide smoothly on the guide rail.

Additionally, since the slide contact portion that is formed on the guide rail is greater in length than the slider, the entire slide contact portion does not simultaneously contact the slider; namely, points (portions) of the entire slide contact portion sequentially come in slide contact with the slider, so that the slide contact portion does not easily wear (if the slide contact portion is formed on the slider, the entire slide contact portion will contact the guide rail at all times when the slider slides on the guide rail, which makes the slide contact portion wear easily).

The present disclosure relates to subject matter contained in Japanese Patent Application No. 2011-243056 (filed on Nov. 7, 2011) and Japanese Patent Application No. 2011-243057(filed on Nov. 7, 2011) which are expressly incorporated herein by reference in their entireties.

### BRIEF DESCRIPTION OF THE DRAWINGS

The present invention will be discussed below in detail with reference to the accompanying drawings, in which:

FIG. 1 is a side elevational view of a vehicle door, in which an embodiment of a window regulator according to the present invention is installed, in a state where a door-trim panel is removed from the vehicle door while a portion of an outer panel of the vehicle door is cut away for the sake of illustration;

FIG. 2 is an exploded perspective view of the window regulator, viewed from the vehicle exterior side;

FIG. 3 is a perspective view of the window regulator, viewed from the vehicle exterior side; and

FIG. 4 is a sectional view taken along the line IV-IV shown in FIG. 3.

### DESCRIPTION OF THE EMBODIMENT

An embodiment of the present invention will be herein discussed with reference to the drawings. Directions described in the following description are defined based on the directions of arrows shown in the drawings.

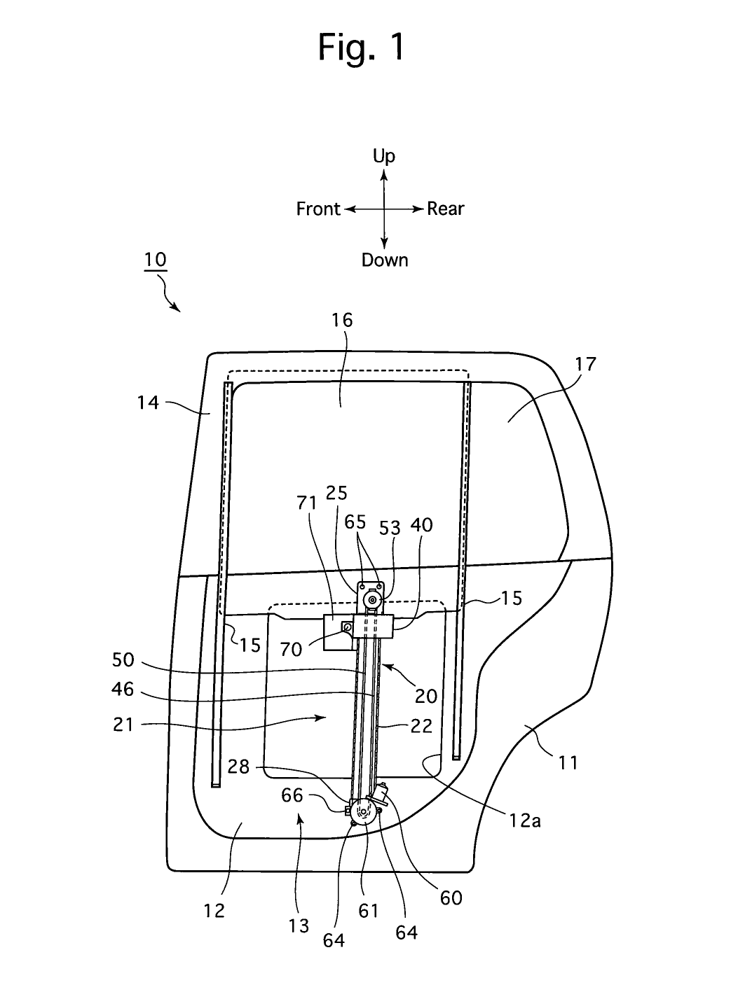

FIG. 1 is a side elevational view of a vehicle door 10 that is rotatable (hinged) about an axis extending vertically to open and close a side opening of a vehicle body (not shown) of a vehicle (automobile), as viewed from the external side of the vehicle.

The vehicle door 10 is provided with an outer panel (door panel) 11, an inner panel (door panel) 12, a door sash 14 and a pair of (front and rear) glass guides 15. The outer panel 11 is made of metal and constitutes a lower half of the exterior side of the vehicle door 10. The inner panel 12 is made of metal, and the outer edge of the inner panel 12 is fixed to the outer edge of the vehicle interior side of the outer panel 11 except the upper edge thereof. The door sash 14 has an inverted U-shape, constitutes an upper half of the vehicle door 10 and is fixed to a vehicle interior side of the outer panel 11. The pair of glass guides 15 are fixed to the vehicle interior side of the outer panel 11. A regulator accommodation space 13, the top of which is open, is formed between the outer panel 11 and the inner panel 12. A guide groove (front guide groove; not shown) is formed in the rear surface of the front glass guide 15 and a guide groove (rear guide groove; not shown) is formed in the front surface of the rear glass guide 15. A slide windowpane 16 made of glass is installed and supported between the front and rear glass guides 15 to be slidable in the vertical direction with the front and rear edges of the slide windowpane 16 fitted in the front and rear guide grooves of the front and rear glass guides 15, respectively. The slide windowpane 16 can be raised and lowered along the front and rear glass guides 15 between a fully closed position (upper movement limit position; see FIG. 1) to fully close a window opening (front window opening) formed between the outer panel 11 and the door sash 14, and a fully open position (lower movement limit position; not shown) to almost fully open the window opening. In addition, another window opening (rear window opening) is formed between the rear glass guide 15 and the door sash 14, and a fixed windowpane 17 which is identical in shape to this rear window opening is fixedly fitted in this rear window opening.

The vehicle door 10 is provided in the regulator accommodation space 13 with a window regulator 20 for raising and lowering the slide windowpane 16.

The window regulator 20 is provided with a guide rail unit 21 made of resin. The guide rail unit 21 is provided with a guide rail 22 which constitutes a major part of the guide rail unit 21 except the upper and lower ends of the guide rail unit 21. The guide rail unit 21 is further provided with a pulley support member 25 and a drum housing 28 which constitute upper and lower ends of the guide rail unit 21, respectively.

The resin-made guide rail 22 is substantially U-shaped in cross section and is provided with a guide rail body 22c which includes a base plate 22a and a pair of guide walls 22b. The base plate 22a extends vertically (in a direction parallel to the up/down direction of the slide windowpane 16), and the pair of guide walls 22b project toward the vehicle exterior side from the front and rear edges of the base plate 22a, respectively.

In addition, two first protrusions (slide contact portions) 23 are provided on an outer surface of the guide rail body 22c and two second protrusions (slide contact portions) 24 are provided on the inner surface of the guide rail body 22c. The first protrusions 23 and the second protrusions 24 each extend over the length of the guide rail body 22c. As shown in the drawings, each first protrusion 23 is provided, on a fixing surface thereof which is fixed to the guide rail 22, with a deformation allowable groove (hollow portion) 23a which is recessed in a direction away from the guide rail 22 and extends over the length of the first protrusion 23.

The guide rail 22 is an integrally molded product made by extrusion molding (double molding) using two types of resin materials; specifically, PP-LGF (Long Glass Fiber Reinforced Polypropylene) that forms the guided rail body 22c, and POM (polyacetal) that forms the two first protrusions 23 and the two second protrusions 24. The resin material (POM) which forms the two first protrusions 23 and the two second protrusions 24 is smaller in slide friction resistance against a slider 40 (which will be discussed in detail later) than the resin material which forms the base plate 22a and the pair of guide walls 22b.

The pulley support member 25 that is made of resin is provided with a mounting through-hole 26 which is formed through the pulley support member 25 in the vehicle widthwise direction toward the vehicle exterior side, and a front and rear pair of through-holes 27 which are formed above the mounting through-hole 26, with respect to the vertical direction. The pulley support member 25 is provided on the lower end surface (the bottom) thereof with a connecting hole (not shown) having a U-shaped cross section (identical to the cross sectional shape of the guide rail body 22c).

The drum housing 28 that is made of resin is provided on a vehicle exterior side thereof with a drum mounting recess 29 which is substantially U-shaped in a side view. The drum housing 28 is provided, in the drum mounting recess 29 at a center thereof, with a rotation support projection 30 which projects toward the vehicle exterior side. The drum housing 28 is provided on a vehicle exterior side thereof with a substantially U-shaped drum covering wall 31 which surrounds the periphery of the drum mounting recess 29. The drum housing 28 is provided on the upper end surface thereof with a connecting hole 32 having a U-shaped cross section (identical to the cross sectional shape of the guide rail body 22c). Three projections are integrally formed on the outer periphery of the drum covering wall 31, and a female screw hole 33 is formed in two of the three projections while a bolt insertion hole 34 is formed through the remaining one of the three projections.

The slider 40 that is an integrally-molded product made of resin is installed in the guide rail unit 21 to be slidable thereon. For instance, PA66-GF can be used as the resin material of the slider 40.

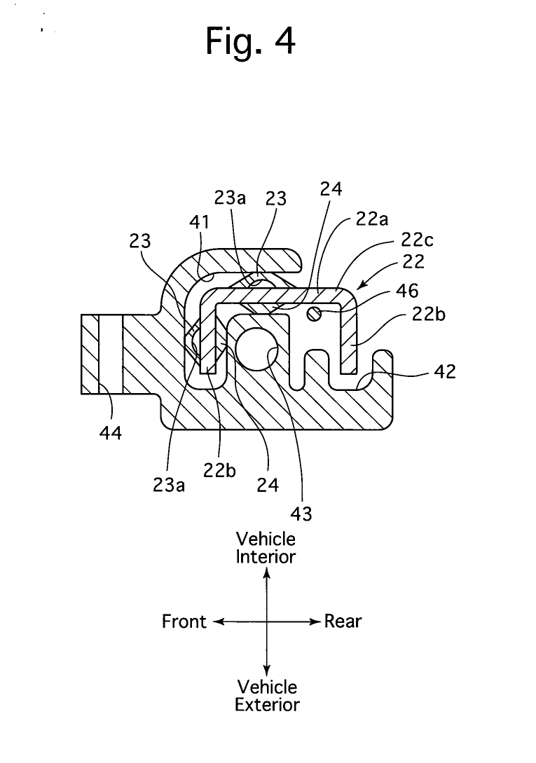

The slider 40 has a cross sectional shape as shown in FIG. 4 and is provided with an engaging groove 41 which extends vertically and has an L-shaped cross section. The upper, lower and rear end surfaces of the engaging groove 41 are open. The slider 40 is provided with a supplemental engaging groove 42 which extends vertically and a wire fixing hole 43 which passes through the slider 40 in the vertical direction. The slider 40 is further provided at the front end thereof with a projection through which a bolt insertion hole 44 is formed to extend in the widthwise direction (vertical direction with respect to FIG. 4) of the vehicle.

A first wire (drive wire) 46 and a second wire (drive wire) 50, both of which are made of metal, are each fixed at one end thereof to the slider 40.

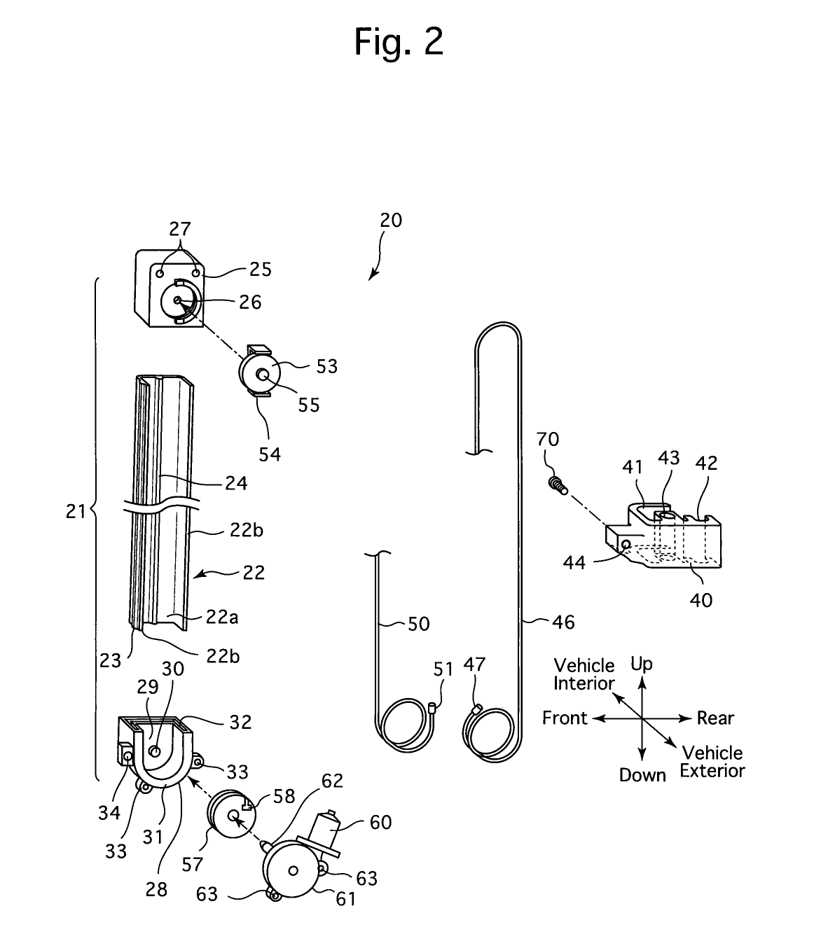

As shown in FIG. 2, a stopper 47 which is greater in diameter than the first wire 46 is fixed to one end of the first wire 46, while another stopper (not shown) is fixed to the other end of the first wire 46. Whereas, a stopper 51 which is greater in diameter than the second wire 50 is fixed to one end of the second wire 50, while another stopper (not shown) is fixed to the other end of the second wire 50.

Each of the first wire 46 and the second wire 50 is fixed to the slider 40 so that of the slider 40 is in the state of being separated from the guide rail unit 21. More specifically, the opposite end of the first wire 46 from the stopper 47 side is inserted into the wire fixing hole 43 from above so as to be retained therein, while the opposite end of the second wire 50 from the stopper 51 side is inserted into the wire fixing hole 43 from below so as to be retained therein.

Thereafter, the integrated member thus assembled that is composed of the slider 40, the first wire 46 and the second wire 50 is installed onto the guide rail 22. More specifically, this integrated member is brought close to the upper end of the guide rail 22, and subsequently, the upper end of a front half of the guide rail 22 is fitted into the engaging groove 41 of the slider 40 from below, while the upper end of the rear guide wall 22b is fitted into the supplemental engaging groove 42 of the slider 40 from below. Thereupon, an inner surface of the engaging groove 41 comes in contact with the upper ends of the first protrusions 23 and the second protrusions 24 to thereby limit movements of the slider 40 in both the forward/rearward direction (horizontal direction with respect to FIG. 4) and the vehicle widthwise direction (vertical direction with respect to FIG. 4).

The guide rail unit 21, which is made up of the guide rail 22, the pulley support member 25 and the drum housing 28, is assembled by fixedly fitting the aforementioned connecting hole (not shown) that is formed in the lower end surface of the pulley support member 25 and the connecting hole 32 that is formed in the upper end surface of the drum housing 28 onto the upper and lower ends of the guide rail 22, respectively, onto which the slider 40 has been installed in the above described manner.

When the slider 40 is installed onto the guide rail 22, it is possible for the integrated member that is composed of the slider 40, the first wire 46 and the second wire 50 to be brought close to the lower end of the guide rail 22 from below and for the lower end of a front half of the guide rail 22 to be subsequently fitted into the engaging groove 41 of the slider 40 from above while the lower end of the rear guide wall 22b be fitted into the supplementary engaging groove 42 of the slider 40 from above. Additionally, the slider 40 can be installed onto the guide rail 22 after the pulley support member 25 or the drum housing 28 is fixed onto the guide rail 22.

A middle section of the first wire 46 is wound around a wire support groove formed over the entire periphery of a pulley (wire orientation changing member) 53. The pulley 53 is rotatably supported by a metal bracket 54 via a rotation support shaft 55 which extends in the vehicle widthwise direction. The bracket 54 is provided with a bolt (not shown) which projects from the back of the bracket 54. This bolt of the bracket 54 is inserted into the mounting through-hole 26 from the vehicle external side, and the bracket 54 is fixed to the pulley support member 25 by screwing a nut (not shown) onto the end of the bolt which projects toward the vehicle interior side from the vehicle interior side of the bracket 54.

The end of the first wire 46 on the stopper 47 side and the end of the second wire 50 on the stopper 51 side are fixed to the drive drum 57. A support groove is formed over the entire periphery of the drive drum 57, and two engaging recesses 58 (only one of which is shown in FIG. 2) are formed in opposite sides of the drive drum 57 to be communicatively connected to the above-mentioned wire support groove, respectively. The stoppers 47 and 51 are respectively fitted into the two engaging recesses 58 while being prevented from coming out, and a section of the first wire 46 in the vicinity of the end thereof on the stopper 47 side and a section of the second wire 50 in the vicinity of the end thereof on the stopper 51 side are wound around the above-mentioned wire support groove, respectively (however, the winding directions of the first wire 46 and the second wire 50 are mutually opposite). The drive drum 57 is provided on a rotation axis thereof with a central through-hole, and the drive drum 57 is accommodated in the drum mounting recess 29 of the drum housing 28 with the end of the aforementioned central through-hole on the vehicle interior side being rotatably fitted onto the rotation support projection 30 of the drum housing 28.

The drive drum 57 is rotatably driven by a motor 60 which is fixed to a metal motor bracket 61, which is disk shaped. The motor bracket 61 is provided with a rotation support shaft 62 which projects toward the vehicle interior side and two radial projections through which two through-holes 63 are formed, respectively. The motor bracket 61 is fixed to the drum housing 28 while being in contact with a vehicle exterior side of the drum cover wall 31 by fitting the rotation support shaft 62 into the vehicle exterior end of the central through-hole of the drive drum 57 in a relatively rotatable manner and screwing two bolts 64 (see FIG. 1) that are inserted into the two through-holes 63 from the vehicle exterior side into the two female screw holes 33, respectively. Once the motor bracket 61 is fixed to the drum housing 28, the drive drum 57 supported by the rotation support shaft 62 becomes rotatable within the drum mounting recess 29; at the same time, the output rotary shaft (not shown) of the motor 60 becomes associated with the drive drum 57 via a reduction gear mechanism (not shown).

As described above, the guide rail unit 21, the slider 40, the first wire 46 (the stopper 47), the second wire 50 (the stopper 51), the pulley 53 (the bracket 54 and the rotation support shaft 55), the drive drum 57, the motor 60, the motor bracket 61 and the bolts 64 are components of the window regulator 20. The window regulator 20, which is unitized as described above, is installed in the regulator accommodation space 13 of the vehicle door 10 through a work opening 12a formed in the inner panel 12, and the window regulator 20 is fixed to the outer panel 11 and the inner panel 12 by screwing two bolts 65 (which are inserted, from the vehicle interior side, into two through-holes 27 which are formed through an upper end of the pulley support member 25) into two female screw holes formed in a stationary member (not shown) fixed to a vehicle interior side of the outer panel 11 and also by screwing a bolt 66 (which is inserted into the aforementioned bolt insertion hole 34 from the vehicle exterior side) into a female screw hole formed in a stationary member (not shown) fixed to a vehicle exterior side of the inner panel 12.

Additionally, a window holder 71 is fixed to the lower edge of the slide windowpane 16, and subsequently, the windowpane 16 is lowered to make the window holder 71 face the slider 40. Thereafter, the end of a bolt 70 which is inserted into the bolt insertion hole 44 of the slider 40 from the vehicle interior side is screwed into a female screw hole (not shown) of the window holder 71 to fix the slider 40 and the window holder 71 to each other. Thereafter, a door trim (not shown) is fixed to a vehicle interior side of the inner panel 12 to thereby complete the vehicle door 10.

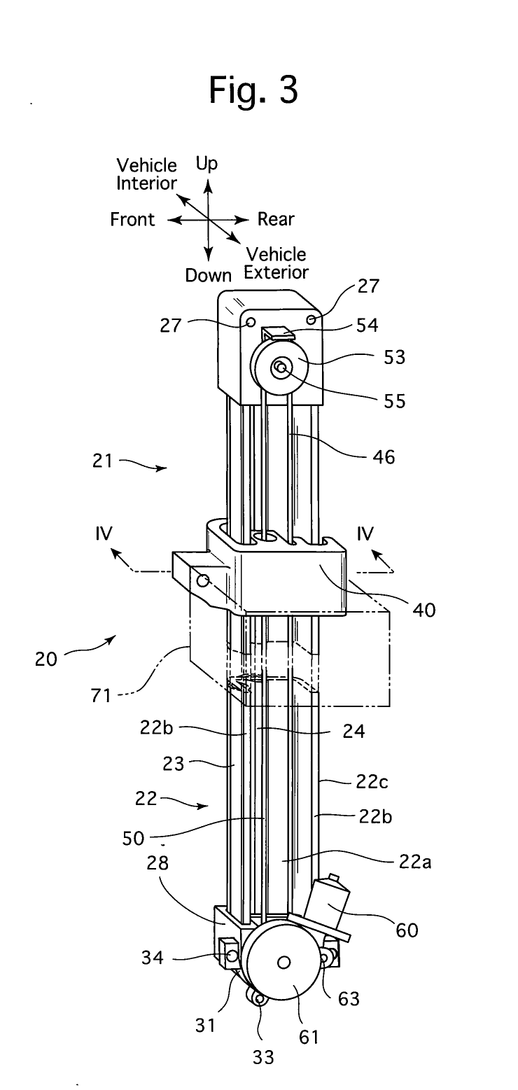

Manually operating a window switch (not shown) provided on the aforementioned door trim of the vehicle door 10 in a window opening direction from an initial position (neutral position) causes the motor 60 to receive current from a power supply (not shown) to thereupon rotate forward, which causes the drive drum 57 to rotate counterclockwise with respect to FIGS. 1 through 3. Thereupon, the first wire 46 is sent out from the drive drum 57 while the second wire 50 is taken up by the drive drum 57, and sections of the first wire 46 and the second wire 50 which are positioned in front of the pulley 53 move down while rotating the pulley 53, while other sections of the first wire 46 and the second wire 50 which are positioned behind the pulley 53 move up; therefore, the slider 40 and the slide windowpane 16 move down along the guide rail 22. On the other hand, manually operating the above-mentioned window switch in a window closing direction from the initial position causes the motor 60 to receive current from the above-mentioned power supply (not shown) to thereupon rotate in reverse, which causes the drive drum 57 to rotate clockwise with respect to FIGS. 1 through 3. Therefore, the second wire 50 is ejected from the drive drum 57 while the first wire 46 is taken up by the drive drum 57, and sections of the first wire 46 and the second wire 50 which are positioned in front of the pulley 53 move up while rotating the pulley 53, while other sections of the first wire 46 and the second wire 50 which are positioned behind the pulley 53 move down; therefore, the slider 40 and the slide windowpane 16 move up along the guide rail 22. Upon the window switch being made to return to the initial position, the current supply to the motor 60 is cut off, so that the motor 60 stops rotating.

In the illustrated embodiment, since the guide rail 22 is made as an extrusion product made of resin, a reduction in weight of the guide rail 22 can be achieved compared with the case where the guide rail body 22c is made of metal (e.g., steel); moreover, the production cost of the guide rail 22 can be reduced (compared with a guide rail made as a resin-made injection-molded product).

Furthermore, since the guide rail 22 is made as an extrusion product, the production cost is low even though the guide rail 22 is produced by double molding using two types of resin materials.

In addition, the two first protrusions 23 and the two second protrusions 24 of the guide rail 22 are made of a resin material (POM) which is smaller in slide friction resistance against the slider 40 than the resin material which forms the guide rail body 22c. Therefore, if the guide rail 22, the first and second protrusions 23 and 24 of which are each made of the same material as the guide rail body 22c, is experimentally prepared as a comparative guide rail and if this experimental guide rail is compared with the guide rail 22 of the present embodiment under the same conditions (e.g., the same temperature and humidity conditions), the slider 40 can be made to slide more smoothly on the guide rail 22 of the present embodiment than on the experimental guide rail because the slider 40 has a smaller slide friction resistance with respect to the first protrusions 23 and the second protrusions 24 of the guide rail 22 of the present embodiment.

Additionally, since the guided rail body 22c is made of PP-LGF (Long Glass Fiber Reinforced Polypropylene), the guide rail body 22c is high in stiffness. Accordingly, the guide rail 22 can support the slider 40 with stability.

Additionally, since the first protrusions 23, the second protrusions 24 and the slider 40 are each made of resin, the guide rail 22 does not have to be greased to smoothen the sliding movements of the slider 40. Accordingly, there is no possibility of the hands of the assembly worker getting dirty during installation of the guide rail 22 to the vehicle door 10. Moreover, since the application of grease to the guide rail 22 is not required, the production cost of the guide rail 22 is also decreased.

Additionally, since the first protrusions 23 and the second protrusions 24 that are formed on the guide rail 22 are greater in length than the slider 40 in the vertical direction, the entire part of each of the first and second protrusion 23 and 24 does not simultaneously contact the slider 40; in other words, points (portions) of the entire part of each of the first and second protrusion 23 and 24 sequentially come in sliding contact with the slider 40, so that the first protrusions 23 and the second protrusions 24 do not easily wear (if slide contact portions corresponding to the first protrusions 23 and the second protrusions 24 are formed on the slider 40, the entire part of each slide contact portion on the slider 40 will be contacting the guide rail 22 at all times when the slider 40 slides, which causes the above-mentioned slide contact portions to easily wear).

Additionally, since the deformation allowable groove 23a is formed in each of the two first protrusions 23, the front first protrusion 23 is resiliently deformable in the forward/rearward direction while the rear first protrusion 23 is resiliently deformable in the vehicle widthwise direction. Therefore, when the slider 40 (the slide windowpane 16) vibrates in the widthwise direction or the forward/rearward direction of the vehicle, such vibration can be absorbed by the two first protrusions 23.

Although the present invention has been described based on the above illustrated embodiment, various modifications to the above illustrated embodiment are possible.

For instance, the guide rail body 22c and the slider 40 can be made of metal (e.g., steel).

In addition, the first protrusions 23, the second protrusions 24 and the guide rail body 22c can firstly be molded separately, and thereafter integrated into a single unit. For instance, it is possible for the resin guide rail body 22c to be molded by a primary injection molding process, and thereafter, the first protrusions 23 and the second protrusions 24 to be molded onto the surface of the guide rail body 22c by a secondary injection molding process (insertion molding). Additionally, it is possible for the metal guide rail 22c to be molded by press molding, or the like, and thereafter, the first protrusions 23 and the second protrusions 24 to be molded onto the surface of the guide rail body 22c by injection molding (insertion molding).

In addition to each first protrusion 23 being provided therein with the deformable allowable groove 23a, each second protrusion 24 can also be provided therein with a deformation allowable groove (hollow portion) corresponding to the deformation allowable groove 23a.

Additionally, each first protrusion 23 can be provided with a through-hole as a hollow portion which extends in the vertical direction instead of the deformable allowable groove 23a. Likewise, each second protrusion 22 can be provided with a through-hole as a hollow portion which extends in the vertical direction instead of a deformable allowable groove corresponding to the deformable allowable groove 23a.

The cross sectional shapes of the first protrusions 23 and the second protrusions 24 can be different from those described above.

The guide rail body 22c, the first protrusions 23, the second protrusions 24 and the slider 40 can be molded from a different resin material from the above described resin material, so long as the resin material of the first protrusions 23 and the second protrusions 24 has a smaller sliding contact resistance with respect to the slider 40 than that of the guide rail body 22c. For instance, the combinations of resin materials shown in Table below are available. The resin material of the slider 40 can be impregnated with glass fibers as necessary.

| Combination | 1^{st} & 2^{nd} protrusions | |
|---|---|---|
| Examples | 23 & 24 | Slider 40 |
| Example 1 | POM | PA66 |
| Example 2 | High-lubricity POM | POM |
| Example 3 | POM | PBT |

Additionally, the guide rail 22 can be molded from three or more types of resin materials, so long as the resin material of the first protrusions 23 and the second protrusions 24 has a smaller sliding contact resistance with respect to the slider 40 than that of the guide rail body 22c.

Instead of the pulley 53, a fixed type wire guide which is nonrotatable and provided on the periphery thereof with a wire support groove can be fixed to the pulley support member 25.

Additionally, more than one wire orientation changing member can be provided. For instance, the guide rail unit 21 can be provided at both upper and lower ends thereof with a pair of wire orientation changing members, respectively, and the drive drum 57 can be installed at a position different from the positions of the pair of wire orientation changing members.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A window regulator for a vehicle, comprising:
a slider fixed to a slide windowpane which moves up and down relative to a door panel of a vehicle door of said vehicle;
a guide rail which is fixed to said door panel, extends in an up/down direction of said slide windowpane and supports said slider in a manner to allow said slider to slide on said guide rail in said up/down direction;
a wire orientation changing member provided said guide rail;
a drive wire which is wound around said wire orientation changing member, wherein said drive wire moves up and down with said slider;
a drive drum which moves said drive wire up and down; and
a slide contact portion, made of resin, which is provided on said guide rail, extends in said up/down direction and is greater in length than said slider in said up/down direction, wherein said slider slides on said slide contact portion when said slider moves up and down.

2. The window regulator for a vehicle according to claim 1, wherein said slide contact portion comprises a protrusion which protrudes toward said slider.

3. The window regulator for a vehicle according to claim 2, wherein a hollow portion is formed in said protrusion, said hollow portion extending in an elongated direction of said protrusion.

4. The window regulator for a vehicle according to claim 1, wherein said guide rail is an extrusion product made of resin.

5. The window regulator for a vehicle according to claim 4, wherein said guide rail is a product molded out of at least two types of resin materials, and
wherein said slide contact portion is made of a resin material which has a smaller slide friction resistance with respect to said slider than a resin material of a portion of said guide rail other than said slide contact portion.
